(19) United States
(12) Patent Application Publication
(10) Pub. No.: US 2026/0328548 A1
(43) Pub. Date: Oct. 22, 2026

(54) A CARTRIDGE TRIMMING TOOL

(71) Applicant: Christopher Mark READE, PITCHCOMBE (GB)

(72) Inventors: Christopher Mark READE, PITCHCOMBE (GB); Nick READE, CAM (GB)

(21) Appl. No.: 19/106,642

(22) PCT Filed: Aug. 25, 2023
(86) PCT No.: PCT/GB2023/052210

§ 371 Date: Feb. 26, 2025

(30) Foreign Application Priority Data
Aug. 26, 2022 (GB) 2212408.5

(51) Int. Cl. F42B 33/10; B23B 5/16; B23B 51/10

(52) U.S. Cl. CPC F42B 33/10; B23B 5/167; B23B 51/103

(57) ABSTRACT

A cartridge trimming tool (10) for trimming an opening (2b) of a cartridge (2), comprising: a rotary cutting bit (40) having trimming blades (42) protruding from its first end, the trimming blades (42) comprise at least one first blade (42a) and at least one second blade (42b) evenly distributed around a longitudinal axis of the rotary cutting bit (40), wherein upon rotating the rotary cutting bit (40) the first and second blades (42a, 42b) are configured to simultaneously chamfer respective inner and outer surfaces of the opening (2b).

### FIELD

The present invention relates to a cartridge trimming tool, and in particular to a cartridge trimming tool for trimming an opening of a cartridge.

### BACKGROUND

With a sharp rise in material and transportation costs in recent years, the practice of recycling spent ammunition cartridges has become ever more popular amongst both competitive and target shooters. Additionally, recycling cartridges safeguards against supply shortages, which has become a common occurrence during the recent pandemic. It is estimated that as many as several hundred million rounds of ammunition a year are reloaded/recycled by refilling spent cartridges with gunpowder before coupling with new primer and bullets.

In addition to cutting costs, some users may opt to reload their ammunition for improved accuracy. For example, the bullets of factory-made ammunition are often positioned far back into the cartridges such that the ammunition can be easily loaded into most firearm magazines. By reloading and repositioning the bullet there will be an improvement in accuracy compared to factory made ammunition

A round of ammunition typically comprises a cartridge having a bullet that fits to an opening, or mouth, at one end. Specifically, internal and external chamfers are circumferentially provided at the opening to allow the bullet to seat more easily. During firing, the cartridge expands and lengthens due to a considerable increase in internal pressure, wherein the chamfered opening may deform or burr after each shot, affecting the accuracy during subsequent uses. Thus, prior to reloading a user may trim the opening to deburr, as well as restore the cartridge to its original length and recreate the chamfers at the opening.

Due to the fact that both internal and external chamfers are relatively small, e.g. 0.2 mm long in most cases, and that on smaller calibres ammunition the wall thickness of the cartridge is incredibly thin, chamfering and resizing the cartridge accurately and consistently has proven to be highly complex and challenging.

There are existing trimming tools that require performing shortening and creating the inner and outer chamfers separately, e.g. with the use of various pieces of hand tools. In addition, there are commercially available trimming tools that allow the trimming processes to be carried out simultaneously. However, these trimming tools are often difficult to set up to create the correct internal and external chamfers, and may require a significant amount of readjustment when switching between cartridges of different calibres.

Therefore, a cartridge trimming tool that allows simultaneous and precise creation of inner and outer chamfers and length on a spent cartridge, as well as being easily adaptable for trimming cartridges of different sizes, is highly desirable.

### SUMMARY

According to a first aspect of the present invention, there is provided a cartridge trimming tool for trimming an opening of a cartridge, comprising:
a rotary cutting bit having trimming blades protruding from its first end, the trimming blades comprise at least one first blade and at least one second blade evenly distributed around a longitudinal axis of the rotary cutting bit, wherein upon rotating the rotary cutting bit the first and second blades are configured to simultaneously chamfer respective inner and outer surfaces of the opening.

The cartridge, sometimes referred to as a cartridge case, may be reloaded with a new bullet, gunpowder and a primer to form reloaded ammunition rounds in a wide range of calibres for various types of firearms. The cartridge may be a spent cartridge or a new cartridge that has not been previously fired.

The rotary cutting bit may resemble an ordinary rotary drill bit where the trimming blades may protrude or extend from an end surface of the first end. The maximum width of the rotatory cutting bit may remain constant along its length. That is, the trimming blades may not protrude from the side of the rotary cutting bit.

The rotary cutting bit may extend along its longitudinal axis, e.g. its centreline, whereby the trimming blades may be evenly distributed around the longitudinal axis. Advantageously, such an arrangement may provide a balanced weight distribution, hence during use it may reduce the amount of vibration, which is critical in precision machining.

The trimming blades may comprise at least one first blade and at least one second blade respectively corresponding to the inner and outer surfaces of the opening, e.g. the leading region at the mouth of the cartridge. The offsets of the first and second blades relative to the longitudinal axis are slightly different, e.g. by the thickness of the cartridge wall. As such, when the cartridge is aligned with the longitudinal axis of, and biased towards, the rotary drill bit, the first and second blades may abut the respective inner and outer surfaces of the opening, thereby simultaneously and accurately creating the inner and outer chamfers.

The rotary cutting bit may be sized to trim ammunition of a particular calibre or type. That is, the radial positions of the first and second blades may be configured to create predetermined internal and external chamfers suitable for the particular calibre. Thus, different interchangeable rotary cutting bits may be adapted for chamfering ammunition of different sizes, each may have first and/or second blades provided at different radial positions from the other rotary cutting bits. Advantageously, such an arrangement may significantly reduce the adjustment or readjustment required when trimming ammunition of different calibres.

Optionally, the rotary cutting bit comprises a second end opposite to the first end for forming a mechanical connection with a manual or powered driver. For example, the second end of the rotary cutting bit may be detachably coupled with a chuck of a hand drill or a power drill for effecting rotation in the rotatory cutting bit. Optionally, the second end may comprise one or more keyways and/or flats for aiding its coupling onto the chuck, and for preventing relative movement during use.

In some embodiments, during the chamfering, the trimming blades may not reduce the overall length of the cartridge. For example, the trimming blades may only trim the side walls of the cartridge but not remove material from the end of the cartridge.

In the preferred embodiment, during the chamfering, the trimming blades are arranged to reduce the overall length of the cartridge. That is, the extent of cartridge shortening corresponds to the degree of its travel along the longitudinal axis. For example, a user may keep biasing the opening of the cartridge towards the trimming blades to further shorten the cartridge.

Optionally, the trimming blades comprise a pair of first blades and a pair of second blades. Optionally, each of the first blades is arranged at 90° to an adjacent second blade with respect to the longitudinal axis of the rotary cutting bit. In some other embodiments, the trimming blades may comprise n pairs of first blades and n pairs of second blades, with each of the first blades arranged at an angle of 360°/4n to an adjacent second blade with respect to the longitudinal axis of the rotary cutting bit.

Optionally, each of the trimming blades is integrally formed with the rotary cutting bit, and wherein each of the trimming blades having a surface profile, e.g. angled or curved cutting edges, for effecting the chamfering at the first and second surfaces. For example, the trimming blades and the rotary cutting bit may be cast or machined from a single piece of material. Advantageously, such an arrangement may improve the strength and longevity of the rotary cutting bit, and additionally, it may reduce the manufacturing costs.

The surface profiles of the trimming blades may be shaped to create particular internal and external chamfers. Thus, interchangeable rotary cutting bits with different trimming blade surface profiles may be adapted for creating different internal and external chamfers. Advantageously, such an arrangement may reduce the adjustment or readjustment required when creating trimming ammunition requiring different chamfers.

Optionally, the cartridge trimming tool further comprises a mandrel having:
a shaft having a first end receivable inside a channel concentrically extending along the longitudinal axis of the rotary cutting bit, the said first end of the shaft is detachably coupled to the rotary cutting bit such that the mandrel rotates with the rotary cutting bit; and
a cartridge guide formed towards a second end of the shaft, the cartridge guide is sized to conform with, and slidable into, a bore of the cartridge, thereby allowing the cartridge to axially align with the rotary cutting bit.

The channel may be opened at the first end of the rotary cutting bit and closed at its second end. Thus, the closed end of the channel may act as an endstop for limiting the extent of the shaft being inserted therein, thereby ensuring the cartridge guide is clear from the trimming blades. The shaft may comprise one or more keyways or flats for aiding its insertion into the channel. The shaft may be detachably coupled to the rotary cutting bit by a grub screw.

In some embodiments, at least a portion of the cartridge guide is cylindrical in shape and having a greater diameter than that of the shaft. The cartridge guide may be an enlarged portion of the shaft, where the diameter across the said portion of the cartridge guide may correspond to the bore of the cartridge. The cartridge guide may be freely slideably into the bore of the cartridge and the two are relatively rotatable to each other.

In some embodiments, the cartridge guide may have a constant width or diameter along its length. On the other hand, in preferred embodiments, the free end of the cartridge guide may be tapered or roundly tapered, e.g. ogive shaped, to aid its insertion into the bore of the cartridge.

The mandrel may act as an alignment aid such that, when the cartridge slides along the cartridge guide, the opening of the cartridge may accurately fit between the first and second blades. Moreover, since the mandrel is directly coupled to, and rotates with, the rotary cutting bit, its proximity to the trimming blades may eliminate any tilting in the cartridge, thus advantageously the internal and external chamfers may be precisely and uniformly provided around the circumference of the opening.

Optionally, during use, the cartridge guide is arranged to be fully received into, and abuts, the bore of the cartridge, with the opening of the cartridge proud of the cartridge guide. For example, during chamfering, the cartridge guide may be far removed from the opening of the cartridge and thus it may provide sufficient clearance for the first and second blades.

Optionally, the mandrel comprises a groove circumferentially extending around the shaft adjacent to the cartridge guide. For example, the groove, or a neck, may form the narrowest portion along the length of the mandrel. Advantageously, the groove may provide a gap between the trimming blades and the mandrel shaft for discharging trimmed material efficiently.

Optionally, the surface of the cartridge guide is coated with a friction reduction coating, and optionally the friction reduction coating comprises one or more of titanium nitride, titanium aluminium nitride and zirconium. Advantageously, the coating may significantly reduce friction between the cartridge and the rotating cartridge guide, thereby reducing wear on both the cartridge and the cartridge guide, and a buildup of heat therebetween.

According to a second aspect of the present invention, there is provided a cartridge trimming tool for trimming an opening of a cartridge, comprising:
a rotary cutting bit having at least one trimming blade protruding from its first end;
a mandrel comprises a shaft having a first end receivable inside a channel concentrically extending along a longitudinal axis of the rotary cutting bit, the said first end of the shaft is detachably coupled to the rotary cutting bit such that the mandrel rotates with the rotary cutting bit; and a cartridge guide formed towards a second end of the shaft, the cartridge guide is sized to conform with, and slidable into, a bore of the cartridge, thereby allowing the cartridge to axially align with the rotary cutting bit;
wherein upon rotating the rotary cutting bit the at least one trimming blade is configured to chamfer an inner surface and/or an outer surface of the opening as the cartridge slides along the mandrel towards the rotary cutting bit.

Similar to the cartridge trimming tool of the first aspect, the mandrel may act as an alignment aid to accurately fit the opening of the cartridge between the first and second blades, as well as prevent tilting of the cartridge during chamfering.

In the second aspect, the rotary cutting bit may have at least one trimming blade protruding from its first end for trimming the inner surface and/or the outer surface of the opening. The at least one trimming blade may be positioned radially away from the longitudinal axis of the rotary cutting bit and corresponds to the inner and/or outer surfaces of the opening. In some embodiments, the at least one trimming blade may comprise a single trimming blade having plural trimming edges for simultaneously chamfering the inner and outer surfaces of the opening.

Optionally, at least a portion of the cartridge guide is cylindrical in shape and having a greater diameter than that of the shaft.

Optionally, the cartridge guide is coated with a friction reduction coating, and optionally the friction reduction coating comprises one or more of titanium nitride, titanium aluminium nitride and zirconium.

Optionally, during use, the cartridge guide is arranged to be fully received into, and abuts, the bore of the cartridge, with the opening of the cartridge proud of the cartridge guide.

Optionally, the mandrel comprises a groove circumferentially extending around the shaft adjacent to the cartridge guide.

Optionally, the at least one trimming blade comprises at least one first blade and at least one second blade evenly distributed around a longitudinal axis of the rotary cutting bit, wherein upon rotating the rotary cutting bit the first and second blades are configured to simultaneously chamfer respective inner and outer surfaces of the opening and/or reduce the overall length of the cartridge.

Optionally, the trimming blades comprise a pair of first blades and a pair of second blades, and optionally each of the first blades is arranged at 90° to an adjacent second blade with respect to the longitudinal axis of the cartridge trimming tool.

Optionally, the trimming blades are integrally formed with the rotary cutting bit, and wherein each of the trimming blades having a surface profile for effecting the chamfering at the first and second surfaces.

Optionally, with respect to both the first and second aspects of the present invention, the cartridge trimming tool comprises a cylindrical housing concentrically extending with the rotary cutting bit, the cylindrical housing having:
a first housing end comprising a cartridge seat axially aligned with the rotary cutting bit and is rotatable relative to the housing by a bearing; and
a second housing end opposite to the first housing end having an orifice through which a second end of the rotary cutting bit extends and detachably coupled thereto, thereby allowing the housing to rotate with the rotary cutting bit.

The cylindrical housing may surround at least the first end of the rotary cutting bit, as well as the mandrel when it is present. The second end of the rotary cutting bit may extend through the second end of the housing for forming a mechanical connection with the manual or powered driver. In use, the housing may rotate with the rotary cutting bit and cartridge guide.

The cartridge seat may comprise a centre aperture arranged to provide passage for the cartridge, and it may comprise inner tapered sidewalls conforming with a surface profile of the cartridge. The said surface profile may be a shoulder or a tapered sidewall of the cartridge. When the cartridge is inserted through the centre aperture and slides along the cartridge guide, the inner tapered sidewall acts as an endstop for limiting the extent of axial movement in the cartridge. The cartridge seat may be supported by a bearing which allows it to rotate freely relative to the housing. That is, the cartridge seat may remain stationary during use when the housing is rotating about the longitudinal axis.

Optionally, the housing comprising threadedly connected first and second housing parts respectively correspond to the first and second ends of the housing; and wherein the displacement between the trimming blades and the cartridge seat is adjustable by rotating the first housing part relative to the second housing part. Such an arrangement may advantageously allow the extent of cartridge trimming to be precisely controlled. For example, when the first and second housings parts move towards each other, the displacement between the trimming blades and the cartridge seat reduces, thereby allowing more materials to be trimmed from the opening of the cartridge before its axial progression is halted by the cartridge seat.

Optionally, a lock ring is provided at the threaded connection for releasably fixing the displacement between the trimming blades and the cartridge seat, thereby allowing the cartridge to be trimmed to a predetermined length. Advantageously, once tightened the lock ring may prevent relative rotation between the first and second housing parts, thereby it may ensure the said displacement to remain constant during use.

In some other embodiment, the first and second housing parts are slidingly connected for adjusting the displacement between the trimming blades and the cartridge seat. An indexing means may be provided for releasably fixing the two with a predetermined separation.

According to a third aspect of the present invention, there is provided a method of utilising the cartridge trimming tool, comprising the steps of:
inserting a cartridge through the centre aperture of the cartridge seat such that the opening of the cartridge abuts the one or more trimming blades of the rotary cutting bit;
rotating the first housing part relative to the second housing part to adjust the displacement between the trimming blades and the cartridge seat;
tightening the lock ring at the threaded connection to fix the displacement between the trimming blades and the cartridge seat;
rotating the rotatory cutting bit to chamfer the inner surface and/or the outer surface of the cartridge while biasing the cartridge towards the rotatory cutting bit.

Optionally, during the said inserting, align the cartridge with the rotary cutting bit by sliding the cartridge along the cartridge guide.

Features from any one of the first to the third aspects of the present invention may be applicable with any other feature from the other aspects.

### BRIEF DESCRIPTION OF THE DRAWINGS

Embodiments of the invention will now be described with reference to the accompanying drawings in which:

FIGS. 1 and 2 are respectively a cross-sectional view and a side view of a cartridge trimming tool according to an embodiment of the present invention;

FIGS. 3A, 3B, 3C and 3D are respectively a perspective view, a bottom view and different side views of a rotary cutting bit featured in the cartridge trimming tool of FIGS. 1 and 2;

FIGS. 4A, 4B and 4C are respectively a perspective view, a bottom view and a side view of a mandrel featured in the cartridge trimming tool of FIGS. 1 and 2;

FIGS. 5A, 5B, 5C and 5D are respectively a perspective view, a bottom view and different side views of the rotary cutting bit having the mandrel detachably attached thereto; and

FIG. 5E is an enlarged side view of FIG. 5D.

### DETAILED DESCRIPTION

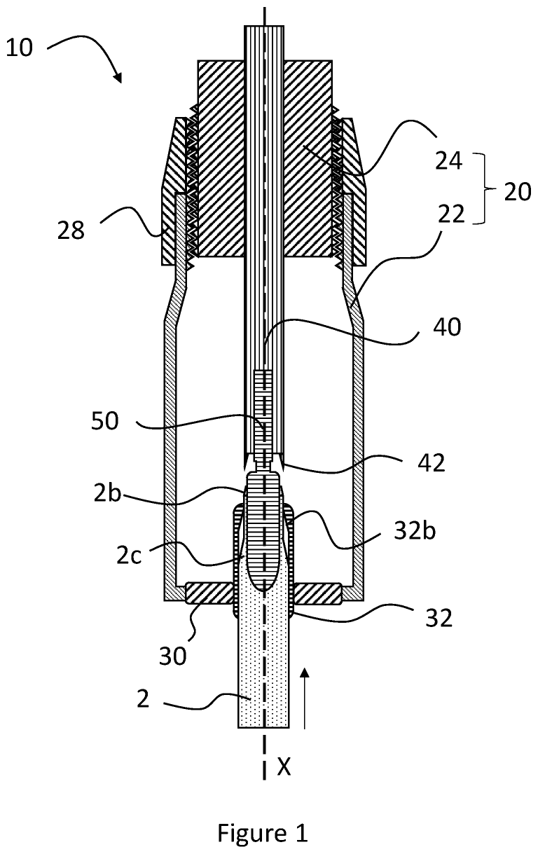

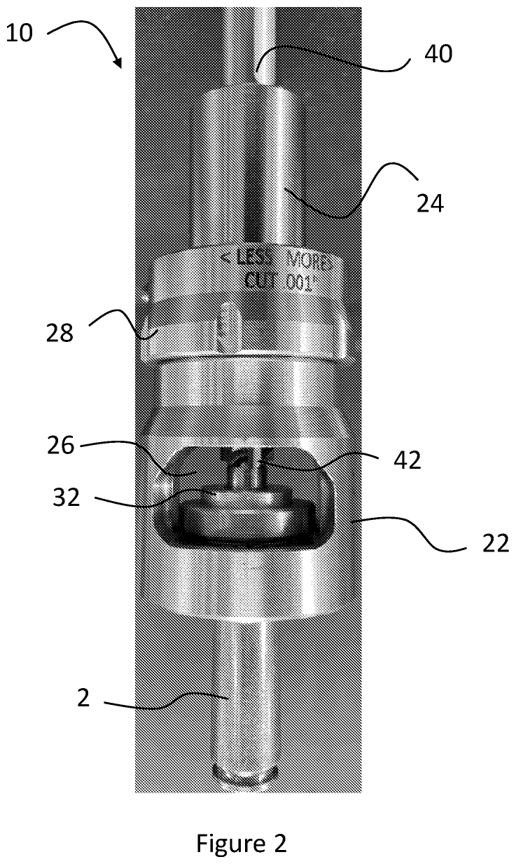

Referring to FIGS. 1 and 2, there is shown a cartridge trimming tool 10 according to an embodiment of the present invention. FIG. 1 is a cross-sectional view illustrating the key components of the cartridge trimming tool 10. FIG. 2 is a front view of the cartridge trimming tool 10. For clarity, some inessential features are not shown but they are nevertheless present.

The cartridge trimming tool 10 comprises a rotary cutting bit 40 configured to chamfer an opening 2b, or a mouth, of a spent cartridge 2. During use, trimming blades 42 protruding from a first end of the rotary cutting bit 40 rotates about a longitudinal axis X to trim the inner and outer surfaces of the cartridge opening 2b, thereby creating internal and external chamfers. As the chamfering process trims material from the said opening 2b, the user may continuously bias the cartridge 2 towards the trimming blades 42 until cartridge 2 has shortened to the desired length.

The cartridge trimming tool 10 further comprises a mandrel 50 detachably coupled to, and rotates with, the rotary cutting bit 40 for guiding the cartridge 2 as it is forced towards the trimming blades 42.

As shown in FIG. 1, the cartridge trimming tool 10 comprises a cylindrical housing 20 formed from a first housing part 22 and a second housing part 24. The first and second housing parts 22, 24 are formed from stainless steel but in other embodiments, they may form from any suitable materials such as aluminium and composite materials.

The first housing part 22 and the second housing part 24 are threadedly connected along the longitudinal axis of the cartridge trimming tool 10. Specifically, a female screw thread is provided towards an upper end of the first housing part 22, which receives a corresponding male screw thread at a lower end of the second housing part 24. Thus, the length of the housing 20 is adjustable by rotating the second housing part 24 relative to the first housing part 22.

Furthermore, the said male screw thread at the lower end of the second housing part 24 is receivable into a corresponding female screw thread inside a lock ring 28. As such, once the first and second housing parts 22, 24 are adjusted to the desired length, a user may tighten the lock ring 28 so that it abuts the second housing part 24 to prevent further rotational movement between the first and second housing parts 22,24.

In the illustrated embodiment, the screw threads are arranged such that, a complete rotation in the first housing part 22 relative to the second housing part 24 changes the length of the housing by 0.001″. The first housing part 22 comprises a window 26 opened at its sidewall through which the user may observe the chamfering process. A transparent cover (not shown) is provided surrounding the first housing part 22, so as to shield the user from discharged shrapnels.

The first housing part 22 comprises, at its lower end, a cylindrical cartridge seat 32 centrally aligned with the longitudinal axis X of the housing 20. The cartridge seat 32 is rotatably connected with the first housing part 22 by a bearing arrangement 30, thus during use, the cartridge seat 32 is freely rotatable relative to the housing 20.

As shown in FIG. 1, the cartridge 2 is partially inserted through a central aperture of the cartridge seat 32, with its opening 2b protruding into the interior of the housing 20. The cartridge 2 may slide along the cartridge seat 32 to engage and disengage with the trimming blades 42. The cartridge seat 32 comprises inner tapered sidewalls 32b that conforms with a shoulder 2c of the cartridge 2. The inner tapered sidewalls 32b act as an endstop for limiting the extent of axial movement in the cartridge 2 relative to the rotary cutting bit 40. That is, the cartridge 2 may axially slide along the cartridge seat 32 until its shoulder 2c abuts the tapered sidewalls 32b, thereby preventing further trimming once the cartridge 2 is shortened to the desired length.

The second housing part 24 comprises a longitudinally extending channel through which the rotary cutting bit 40 is received. The rotary cutting bit 40 is detachably coupled to the second housing part 24 by a grub screw (not shown) extending through the side of the second housing part 24. When it is fully tightened, the grub screw does not protrude from the side of the second housing part 24. As such, the housing 20 rotates with the rotary cutting bit during use.

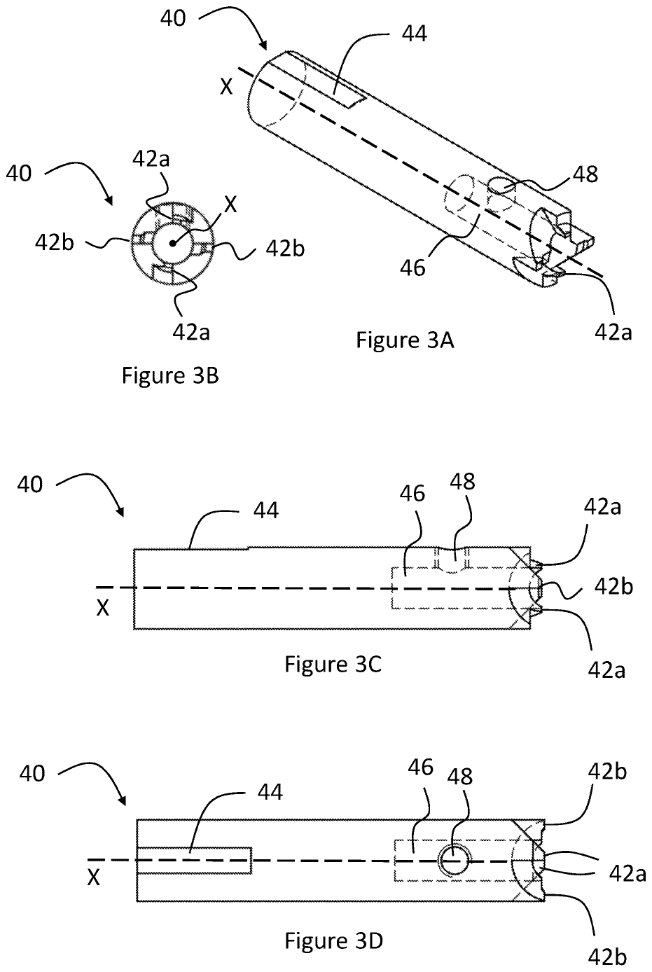

FIGS. 3A and 3B are respectively a perspective view and a bottom view of a rotary cutting bit 40 featured in the cartridge trimming tool of FIGS. 1 and 2. FIGS. 3c and 3d are two side views of the rotary cutting bit 40 taken at 90° degrees apart around its longitudinal axis X.

The rotary cutting bit 40 comprises a first end from which trimming blades 42 extend, and an opposite second end for forming mechanical connection with a manual or powered driver. More specifically, the second end of the rotary cutting bit 40 is connectable with a chuck of a hand drill or a power drill for effecting rotation in the rotatory cutting bit 40. Furthermore, the said second end comprises a flat 44, or a flattened portion, for aiding its coupling onto the chuck, and for preventing relative movement during use.

In the illustrated embodiment, the trimming blades 42 protrude from the first end of the rotary cutting bit 40. The trimming blades 42 are integrally formed with the rotary cutting bit 40 which advantageously increases their durability and lowers the manufacturing costs. The trimming blades 42 comprise a pair of first blades 42a and a pair of second blades 42b for respectively chamfering the inner and outer surfaces of the cartridge opening 2b. As shown in the bottom view of FIG. 3b, the second blades 42b are positioned further away from the centre of the rotary cutting bit than the first blades 42a. The rotary cutting bit 40 is sized to trim ammunition of a particular calibre or type. Thus, different interchangeable rotary cutting bits may be adapted for chamfering ammunition of different sizes, each having first and/or second blades provided at radial positions different from the other rotary cutting bits. In comparison to other commercially available trimmers that require a substantial amount of readjustment, the use of interchangeable rotary cutting bits significantly reduces the time and effort required when switching between cartridges of different calibres.

The first blades 42a and second blades 42b are, in their respective pairs, arranged on opposite sides of the rotary cutting bit 40, e.g. the pairs of first and second blades are each separated by 180° around the longitudinal axis X. Furthermore, each of the first blades is arranged at 90° to an adjacent second blade with respect to the longitudinal axis X. That is, the first and second blades 42a, 42b are evenly distributed around the centre of the rotary cutting bit 40. Advantageously, such an arrangement may provide a balanced weight distribution around the longitudinal axis X, hence during use it may reduce the amount of vibration, which is critical in precision machining.

The surface profiles, or cutting edges, of the trimming blades 42 are shaped to create particular internal and external chamfers at the cartridge opening 2b. Thus, interchangeable rotary cutting bits 40 with different trimming blade surface profiles may be fitted to the second housing part 24 for creating different internal and external chamfers. Advantageously, such an arrangement may reduce the adjustment or readjustment required when creating trimming ammunition requiring different chamfers.

The rotary cutting bit 40 comprises a centrally extending channel 46 opened at its first end through which a shaft 52 of the mandrel 50 is inserted. The channel 46 is closed towards the second end of the rotary cutting bit 40, which defines the extent of the shaft 52 of the mandrel 50 receivable therein. The rotary cutting bit 40 comprises a screw hole 48 extending through its sidewall to the channel 46 for receiving a grub screw (not shown). When fully tightened, the grub screw is fully received in the screw hole 48 and releasably retains the shaft of the mandrel 50 inside the channel 46. As such, the mandrel 50 rotates with the rotatory cutting bit 40 and the housing 20.

In the illustrated example, the rotary cutting bit 40 is 10 mm in diameter and is formed from M2 tool steel hardened to 62/64 Rockwell.

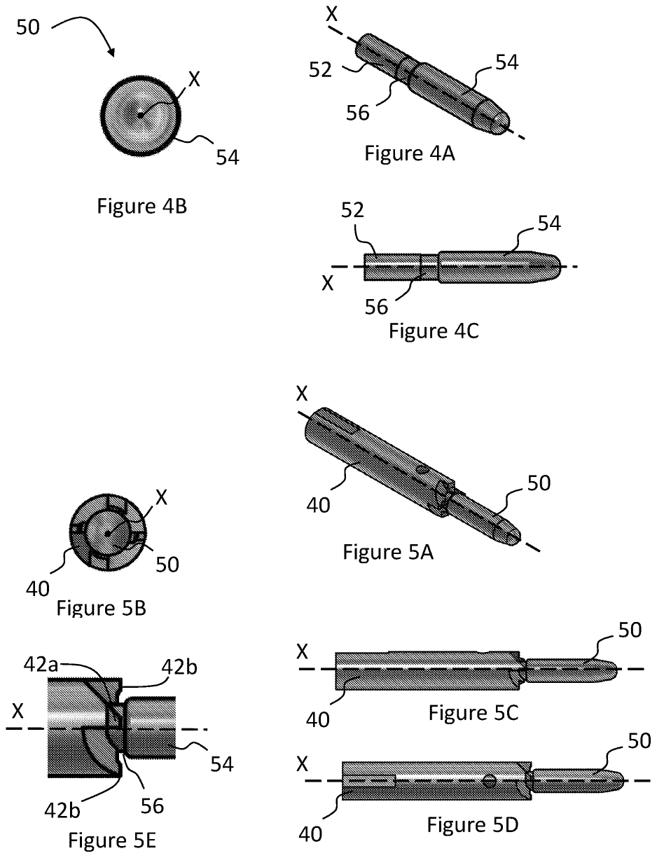

FIGS. 4A, 4B and 4C are respectively a perspective view, a bottom view and a side view of the mandrel 50, and FIGS. 5A, 5B, 5C and 5D are respectively a perspective view, a bottom view and different side views of the rotary cutting bit 40 having the mandrel detachably attached thereto. FIG. 5E is an enlarged side view of FIG. 5D.

The mandrel 50 comprises a cartridge guide 54 formed towards an end of the shaft 52. The cartridge guide 54 is sized to conform with, and slidable into, the bore of the cartridge 2, thereby allowing the cartridge to axially align with the rotary cutting bit during chamfering.

As shown in the side view of FIG. 4C, the foot of the cartridge guide 54 is cylindrical in shape and has a greater diameter, or wider, than that of the shaft. That is, the cartridge guide 54 is an enlarged portion of the shaft 52, where the diameter across the said foot the cartridge guide 54 correspond to the bore of the cartridge 2 to be chamfered. Therefore, the cartridge guide 54 is freely slideably into the bore of the cartridge 2 and the two are relatively rotatable to each other.

The tip of the cartridge guide 54 is roundly tapered, or ogive shaped, to aid its insertion into the bore of the cartridge. During use, the cartridge guide 54 is arranged to be fully received into, and abuts, the bore of the cartridge 2, with the opening 2b of the cartridge 2 proud of the cartridge guide 54, thus it provides sufficient clearance for the first and second blades 42a,42b.

The mandrel 50 acts as an alignment aid such that, when the cartridge 2 axially slides along the cartridge guide 54, the opening 2b of the cartridge 2 may accurately fit between the first and second blades 42a, 42b. Moreover, since the mandrel 50 is directly coupled to, and rotates with, the rotary cutting bit 40, its proximity to the trimming blades 42a, 42b eliminates any tilting in the cartridge 2. Thus, advantageously, the internal and external chamfers can be precisely and uniformly provided around the circumference of the opening 2b.

The mandrel 50 further comprises a groove 56, or a neck, circumferentially extending around the shaft 52 adjacent to the cartridge guide 54. The groove 56 forms the narrowest portion along the length of the mandrel 50. As shown in FIG. 5E, once the shaft 52 is fully inserted into the channel 46 of the rotary cutting bit 40, the groove 56 provides a gap between the trimming blades 42 and the mandrel 50 which allows the trimmed material to be discharged more effectively.

The mandrel 50 is coated with a titanium nitride coating, which reduces friction between the bore of the cartridge 2 and the rotating cartridge guide 54, thereby reducing wear a buildup of heat during use.

Interchangeable mandrels of different sizes and/or designs may be provided for each ammunition calibre depending on the neck tension that is required.

Referring back to FIG. 1, in order to create the internal and external chamfers at the cartridge opening 2b, as well as shortening the cartridge 2 to a desired length, a user may first insert the opening 2b of the cartridge 2 through the central aperture of the cartridge seat 32. As the cartridge 2 is inserted into the cartridge seat 32 its bore abuts, and slides along, the cartridge guide 54, thereby ensuring the cartridge 2 is aligned with the rotary cutting bit 40 along the longitudinal axis.

The cartridge 2 may continue to slide through the cartridge seat 32 until its opening 2b abuts the rotating trimming blades 42 to simultaneously chamfer the inner and outer surfaces of the said opening 2b. The user may continue to bias the cartridge opening 2b against the trimming blades 42 to trim and shorten the length of the cartridge 2, until its shoulder 2b abuts the inner tapered sidewalls 32b of the cartridge seat 32. At this point, the cartridge 2 may not slide any further towards the trimming blades 42, thus halting the trimming process.

The cartridge 2 may be shortened to the desired length by varying the separation between the cartridge seat 32 and the trimming blades 42, e.g. by changing the length of the housing 20. More specifically, a user may rotate the first housing part 22 relative to the second housing part 24 to achieve the required separation, before tightening the lock ring 28 to fix the two housing parts 22, 24 in place. Thus, once the relative positions of the first and second housing parts 22, 24 are set and fixed for a particular calibre, the user may trim many cartridges of the same calibre without needing to reset the cartridge trimming tool 10, thereby significantly improves the efficiency of the trimming process.

The invention may take a form different to that specifically described above.

Further modifications will be apparent to those skilled in the art without departing from the scope of the present invention.

We claim:

1. A cartridge trimming tool for trimming an opening of a cartridge, comprising:
a rotary cutting bit having trimming blades protruding from its first end, the trimming blades comprise at least one first blade and at least one second blade evenly distributed around a longitudinal axis of the rotary cutting bit, wherein upon rotating the rotary cutting bit the first and second blades are configured to simultaneously chamfer respective inner and outer surfaces of the opening, wherein each of the first blades is arranged at 90° to an adjacent second blade with respect to the longitudinal axis of the rotary cutting bit.

2. (canceled)

3. (canceled)

4. The cartridge trimming tool of claim 1, wherein the trimming blades are integrally formed with the rotary cutting bit, and wherein each of the trimming blades having a surface profile for effecting the chamfering at the first and second surfaces.

5. The cartridge trimming tool of claim 1, wherein during the chamfering the trimming blades are arranged to reduce the overall length of the cartridge.

6. The cartridge trimming tool of claim 1, wherein the rotary cutting bit comprises a second end opposite to the first end for forming a mechanical connection with a manual or powered driver.

7. The cartridge trimming tool of claim 1, further comprises a mandrel having:
a shaft having a first end receivable inside a channel concentrically extending along the longitudinal axis of the rotary cutting bit, the said first end of the shaft is detachably coupled to the rotary cutting bit such that the mandrel rotates with the rotary cutting bit; and
a cartridge guide formed towards a second end of the shaft, the cartridge guide is sized to conform with, and slidable into, a bore of the cartridge, thereby allowing the cartridge to axially align with the rotary cutting bit.

8. The cartridge trimming tool of claim 7, wherein at least a portion of the cartridge guide is cylindrical in shape and having a greater diameter than that of the shaft.

9. The cartridge trimming tool of claim 7, wherein, during use, the cartridge guide is arranged to be fully received into, and abuts, the bore of the cartridge, with the opening of the cartridge proud of the cartridge guide.

10. The cartridge trimming tool of claim 7, wherein the mandrel comprises a groove circumferentially extending around the shaft adjacent to the cartridge guide.

11. The cartridge trimming tool of claim 7, wherein the surface of the cartridge guide is coated with a friction reduction coating.

12. The cartridge trimming tool of claim 11,
in which the friction reduction coating comprises one or more of titanium nitride, titanium aluminium nitride and zirconium.

13. (canceled)

14. (canceled)

15. (canceled)

16. (canceled)

17. (canceled)

18. The cartridge trimming tool of claim 1, comprises a cylindrical housing concentrically extending with the rotary cutting bit, the cylindrical housing having:
a first housing end comprising a cartridge seat axially aligned with the rotary cutting bit and is rotatable relative to the housing by a bearing; and
a second housing end opposite to the first housing end having an orifice through which a second end of the rotary cutting bit extends and detachably coupled thereto, thereby allowing the housing to rotate with the rotary cutting bit.

19. The cartridge trimming tool of claim 18, wherein the cartridge seat comprises a centre aperture arranged to provide passage for the cartridge, and inner tapered sidewalls conforming with a surface profile of the cartridge for limiting the extent of axial movement of the cartridge relative to the rotary cutting bit.

20. The cartridge trimming tool of claim 18, wherein the housing comprising threadedly connected first and second housing parts respectively correspond to the first and second ends of the housing; and wherein the displacement between the trimming blades and the cartridge seat is adjustable by rotating the first housing part relative to the second housing part.

21. The cartridge trimming tool of claim 20, wherein a lock ring is provided at the threaded connection for releasably fixing the displacement between the trimming blades and the cartridge seat, thereby allowing the cartridge to be trimmed to a predetermined length.

22. A method of operating the cartridge trimming tool of claim 21, comprising the steps of:
inserting a cartridge through the centre aperture of the cartridge seat such that the opening of the cartridge abuts the one or more trimming blades of the rotary cutting bit;
rotating the first housing part relative to the second housing part to adjust the displacement between the trimming blades and the cartridge seat;
tightening the lock ring at the threaded connection to fix the displacement between the trimming blades and the cartridge seat;
rotating the rotatory cutting bit to chamfer the inner surface and/or the outer surface of the cartridge while biasing the cartridge towards the rotatory cutting bit.

23. (canceled)
